(19) United States
(12) Patent Application Publication
(10) Pub. No.: US 2025/0307751 A1
(43) Pub. Date: Oct. 2, 2025

(54) SYSTEMS AND METHODS FOR GENERATING CHANGES TO WORKPLACE PLANS USING GENERATIVE AI

(71) Applicant: NICE LTD., Ra'anana (IL)

(72) Inventors: Vaibhav CHOBE, Pune (IN); Niranjan BAGADE, Pune (IN); Kanchan VASNANI, Indore (IN)

(73) Assignee: NICE LTD., Ra'anana (IL)

(21) Appl. No.: 18/619,431

(22) Filed: Mar. 28, 2024

(51) Int. Cl. G06Q 10/0637; G06F 40/20; G06Q 10/0631

(52) U.S. Cl. CPC G06Q 10/0637; G06F 40/20; G06Q 10/06311

(57) ABSTRACT

Systems and methods for assessing the feasibility of a proposed contact center work plan are disclosed. The plan may include a proposed workload and a proposed performance metric and the method may include: generating, based on the proposed contact center work plan and data indicative of previous feasible contact center work plans, a feasibility for the proposed contact center work plan; and where the feasibility is below a threshold, generating, using a large language model, a modified contact center work plan for a user with a feasibility above the threshold, the modified contact center work plan comprising a modification to one or more aspects of the contact center work plan.

### FIELD OF THE INVENTION

The present invention relates generally to reviewing workplace plans for workplaces such as contact centers or call centers, to assess feasibility of the workplace plans and to suggest changes where the plans are not feasible.

### BACKGROUND OF THE INVENTION

Within workplaces such as contact centers or call centers, a user, such as a supervisor, may establish or implement a number of workplace plans. Workplace plans may outline, for example, workload to be taken on by the workplace and/or service targets or key performance indicators for the workplace to meet with respect to the workload. Sometimes these plans may also include staffing levels for meeting the workload within the service targets or key performance indicators.

It may be advantageous to assess the feasibility of a workplace plan before its implementation. If the workplace plan is not feasible, it may be advantageous to implement an alternative plan (e.g., a modification of the original). It may be advantageous that a supervisor can easily understand the steps needed to achieve this.

Some prior solutions partially address this problem by requiring supervisors to remember historical service target sets, and the actual targets achieved, for previous work plans, and may rely on their knowledge of a contact center to formulate a realistic workplace plan. These non-automatic prior solutions can be inaccurate, subjective, and time consuming.

### SUMMARY OF THE INVENTION

Embodiments may improve existing technology by providing systems and methods which automatically assess the feasibility of a proposed workplace plan, and, where the plan is deemed to be infeasible, automatically generating changes to the plan (possibly within defined parameters). Embodiments may improve prior technology by formulating plans quickly and possibly automatically, wherein the plans are achievable. Embodiments may reduce user error. Embodiments may allow for messages to be displayed to users/supervisors that are adaptable to different situations, are expressed in fluent language, and wherein responses do not need to be preprogrammed. Customer satisfaction may be improved using embodiments herein.

Embodiments for generating changes to a first plan are disclosed. The first plan may include a workload and a performance metric. An embodiment for generating changes to a first plan may include: estimating whether the first plan is achievable, including: comparing the first plan to at least one instance of workplace data, the workplace data indicative of instances of workload and performance metric, the instances being previous to the time of the first plan, and wherein the first plan may be deemed to be achievable if, for at least one instance of the workplace data, the performance metric of the first plan is less than or equal to a performance metric of the past instance; if the first plan is not deemed to be achievable, generating a modified plan with a higher probability of achievability than a probability of achievability of the first plan, the modified plan including a modification to at least one of the performance metric and the workload; creating a prompt for a generative artificial intelligence (AI) system, the prompt configured to ask for a message for a user, wherein the message states that the first plan should be replaced with the modified plan and states the modification to the performance metric of the modified plan; and receiving from the generative AI system, the message for a user.

Embodiments for generating changes to a first plan are disclosed. The first plan may include a workload and a performance metric. An embodiment may include a memory and a processor. The processor may be configured to: estimate whether the first plan is achievable, including the processor being configured to: compare the first plan to at least one instance of workplace data, the workplace data indicative of instances of workload and, performance metric, the instances being previous to the time of the first plan, and wherein the first plan is deemed to be achievable if, for at least one instance of the workplace data, the performance metric of the first plan is less than or equal to a performance metric of the past instance; if the first plan is not deemed to be achievable, generate a modified plan with a higher probability of achievability than a probability of achievability of the first plan, the modified plan comprising a modification to at least one of the performance metric and the workload; create a prompt for a generative artificial intelligence (AI) system, the prompt configured to ask for a message for a user, wherein the message states that the first plan should be replaced with the modified plan and states the modification to the performance metric of the modified plan; and receive from the generative AI system, the message for a user.

Embodiments for assessing the feasibility of a proposed contact center work plan is disclosed. The plan may include a proposed workload and a proposed performance metric. An embodiment may include: generating, based on the proposed contact center work plan and data indicative of previous feasible contact center work plans, a feasibility (e.g., feasibility score) for the proposed contact center work plan; and where the feasibility (e.g., feasibility score) is below a threshold, generating, using a large language model, a modified contact center work plan for a user with a feasibility (e.g., feasibility score) above the threshold, the modified contact center work plan comprising a modification to one or more aspects of the contact center work plan.

### BRIEF DESCRIPTION OF THE DRAWINGS

The subject matter regarded as the invention is particularly pointed out and distinctly claimed in the concluding portion of the specification. The invention, however, both as to organization and methods of operation, together with objects, features, and advantages thereof, may best be understood by reference to the following detailed description when read with the accompanying drawings in which:

FIG. 1 is a flowchart for generating changes to a plan according to some embodiments of the invention.

FIG. 2 shows a network architecture diagram which may be used with embodiments herein.

FIG. 3 shows a software architecture diagram of at least part of a system which may be used with embodiments herein.

FIGS. 4A and 4B show a flowchart according to some embodiments herein.

FIG. 5 shows a flowchart of a method according to some embodiments of the invention.

FIG. 6 shows an example screenshot of an example graphical user interface according to some embodiments herein.

FIG. 7 shows a block diagram of an exemplary computing device which may be used with embodiments herein.

FIG. 8 shows a schematic drawing of a contact center system according to some embodiments of the invention.

### DETAILED DESCRIPTION OF THE INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, method embodiments described herein are not constrained to a particular order or sequence. Additionally, some of the described method embodiments or elements thereof can occur or be performed simultaneously, at the same point in time, or concurrently.

As used herein, “workplace” may refer to a place in which employees or agents work (e.g., an office or company). It need not be a physical place, but may indicate a particular employer, company, division, etc. The workplace may be assessed using performance metrics. The workplace may operate using plans or planning. It may be optimal to ensure that new plans are feasible or achievable. A workplace may include a contact center or call center.

As used herein, “contact center” or “tenant” may refer to an office or company (e.g., a centralized office) used for receiving or transmitting a large volume of contacts, enquiries, communications, interactions, or calls. The contacts, enquiries, communications, interactions, or calls may use telephone calls, emails, message chats, SMS (short message service) messages, etc. A contact center may, for example, be operated by a company to administer incoming product or service support or information enquiries from customers/consumers. The company may be a contact-center-as-a-service (CCaaS) company. A contact center may use an automatic call distributor (ACD) system for routing contacts or calls to agents. A tenant may be one of several customers, e.g. contact centers, serviced by a cloud computing center or CCaaS.

As used herein, “call center” may refer to a contact center that primarily handles telephone calls rather than other types of enquiries, communications, or interactions. Any reference to a contact center herein should be taken to be applicable to a call center, and vice versa.

As used herein, “interaction”, “contact”, or “call” may refer to a communication between two or more people (e.g., in the context of a contact center, an agent and a customer), typically via devices such as computers, customer devices, agent devices, etc., and may include, for example, voice telephone calls, conference calls, video recordings, face-to-face interactions (e.g., as recorded by a microphone or video camera), etc. An interaction may be recorded to generate one or more data files such as an “interaction recording” or “call recording”, transcripts, metadata, etc. An interaction, or interaction recording/call recording, may also refer to data which is transferred and stored in a computer system recording the interaction and may represent an interaction, including for example the streams of data exchanged during the interaction, voice or video recordings created after the interaction, data items describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), etc. Interactions may be computer-based if, for example, the interaction has associated data or metadata items stored or processed on a computer, the interaction is tracked or facilitated by a server, the interaction is recorded on a computer, data is extracted from the interaction, etc. Some computer-based interactions may take place via the internet, such as conference calls and web chats, whereas some computer-based interactions may take place via other networks, such as some telephone calls. Interactions may be converted into text-based interaction recordings (e.g., using automatic speech recognition).

Interactions may include different interaction types, for example, voice-based interactions (e.g., cellular, phone, or web-based calls), text-based interactions (e.g., SMS or web-based messaging), video-based interactions (e.g., web-based conference calls), face-to-face interactions (e.g., in person), and/or other interactions. Some contact centers may be configured to handle multiple interaction types. They may be handled simultaneously; as used herein “simultaneous handling” may refer to multiple interaction types being handled by a contact center, being encompassed in a plan, being assessed by a performance metric, etc.

As used herein, “agent” may refer to a contact center employee that answers incoming interactions, and may, for example, handle customer requests.

As used herein, “supervisor”, “manager”, or “user” (e.g., the user of systems and methods herein) may refer to a contact center employee that, possibly among other responsibilities, makes or agrees to plans for a contact center. In some embodiments, a “supervisor” may not be a person at all, but rather a supervisor computer system. For example, supervisor actions according to embodiments of the following invention, such as proposing performance metrics for a new service level agreement, may be taken by either a “supervisor” employee, or by a “supervisor” computer system, which may act in accordance with its programming/algorithms.

As used herein, “performance metric”, “performance indicator”, “key performance indicator”, “KPI”, “service target” may refer to a measure of performance of, for example, a workplace such as a contact center. Many performance metrics may exist. They may allow for an understanding of the function of a workplace such as a contact center. They may be used to set targets for a workplace such as a contact center. They may be used to set minimum acceptable levels for a workplace such as a contact center. Performance metrics may be a measure of the performance of a contact center, but additionally or alternatively they may be for each interaction types, for example, voice-based interactions, text-based interactions, video-based interactions, face-to-face interactions, and/or other interactions. Each interaction type may have a different value for a performance metric.

As used herein, “service level” may refer to a type of performance metric. Service level may be defined as a percentage or proportion of contacts that are answered, opened, dealt with, resolved, etc., within a certain time. For one particular example of a service level, there may be a service level of 50% of calls are answered within 1 minute. For another example, there may be a service level of 75% of contacts are resolved within 10 minutes. In some cases or embodiments, service level may be the most commonly used performance metric (e.g., sometimes to the extent that it is used synonymously with “performance metric”, or similar). Embodiments of the invention include service levels that are each defined by for example two values (e.g., floating point numbers). A first number may be defined as a percentage or proportion of contacts that are answered. The first number may lie in a range of 0-100, 0.0-1.0, or another range. A second number may be a time within which the percentage or proportion of contacts are answered. The second number may include any number more than 0. The second number may be defined in units of seconds, minutes, or hours; for example, a same time may be encoded as 180, 3, or 0.05, for units of seconds, minutes, or hours respectively. In some embodiments, a service level may be stored as an array including the first number and the second number; for example, the following may be stored for service levels of 30%, 55%, and 57.7% answered within 10 minutes: [30, 10], [55, 10], [57.7, 10.0]. In some embodiments, metadata may be stored, e.g., indicating the units of time for the second number. Where the second number is constant, it may not need to be stored explicitly, for example, with respect to the above example, the following numbers may be stored: 30, 55, 57.7, or 0.3, 0.55, 0.577. Preferable values of service level may

As used herein, “average wait time”, “wait time”, “average speed of answer”, or “ASA” may refer to a type of performance metric. Wait time may be the amount of time (e.g., on average, e.g., mean) that a contact is waiting to be answered or possibly resolved. For one particular example of an average wait time, there may be an average wait time for a call to be answered of 1 minute 20 seconds. The average wait time may be any number (e.g., floating point number) more than 0. The average wait time may be defined in units of seconds, minutes, or hours; for example, a same time may be encoded as 540, 9, or 0.15, for units of seconds, minutes, or hours respectively. In some embodiments, metadata may be stored, e.g., indicating the units of time for the average wait time. Preferable values of average wait time may be low. A low but realistic average wait time may, for example, be 1-10 minutes.

As used herein, “average handle time” or “AHT” may refer to a type of performance metric. Average handle time may be the amount of time (e.g., on average, e.g., mean) that a contact is waiting to be resolved or possibly answered. For one particular example of an average handle time, there may be an average handle time for a contact to be resolved of 15 minutes. In some cases, average handle time may be synonymous with average wait time. The average handle time may be any number (e.g., floating point number) more than 0. The average handle time may be defined in units of seconds, minutes, or hours; for example, a same time may be encoded as 720, 12, or 0.2, for units of seconds, minutes, or hours respectively. In some embodiments, metadata may be stored, e.g., indicating the units of time for the average handle time. Preferable values of average handle time may be low. A low but realistic average handle time may, for example, be 5-25 minutes.

As used herein, “maximum occupancy” or “occupancy rate” may refer to a type of performance metric. Maximum occupancy may be value (e.g., floating point number) representing the percentage or proportion of time agents spend on “productive” work, e.g., engaging with contacts and calls, and other work relating to contacts and calls. Maximum occupancy may be an upper limit for the average proportion of time an agent is engaged in productive work. Maximum occupancy may lie in a range of 0-100, or alternatively 0.0-1.0. For example the following may be stored as values for maximum occupancy rate: 67, 82, 54.8, or 0.67, 0.82, 0.548. A low occupancy rate (e.g., 40%) may indicate low productivity and/or poor management of resources, whereas an occupancy rate that is too high (e.g., close to 100%) may lead to a decline in the quality of service. A preferable maximum occupancy rate may lie between 75% and 95%

As used herein, “workload” may refer to some level of work for a workplace. For example, it may refer to the amount, volume or number of contacts or interactions handled (e.g., in the past) or proposed to be handled (e.g., in a plan) by a contact center (e.g., within a given time frame). For example, workload may include simultaneous Chat, Text or other contacts being handled. Additionally or alternatively, workload may be defined with respect to a staffing level, e.g., the workload is an amount of work that may be handled by some staffing level. For example, a workload may be defined as an amount of work to be achieved by a team or division or a number of people.

As used herein, “staffing level” may refer to some measure of staffing of a workplace. For example, it may refer to the number of agents (e.g., for each skill type) available to or working at a contact center (or a certain division in a contact center). Staffing level may include a number of agents who worked or will work on delivering a plan or service level agreement, and/or may include a number of workplace teams or divisions (e.g., a schedule unit) who worked or will work on delivering a plan or service level agreement. For example, a workload in terms/units of agents/people may be 100 agents/people, whereas a workload in terms/units of divisions may be 2 (e.g., where each division has 50 agents). In some cases, workload may be considered to be performance metric and/or part of a service level agreement. Workload may be a single number or may have different values for different contact types.

As used herein, “service level agreement”, “SLA”, “workplace plan”, or “plan” may refer to an agreement made between a contact center and another party, which indicates that the contact center will handle interactions while meeting certain performance metrics. The performance metrics indicated in the service level agreement may include service level (e.g., as implied by the name), but may additionally or alternatively include other performance metrics, e.g., as described herein. An SLA or plan may, for example, be stored using an array, e.g., a JSON array. The SLA or plan may be stored in an intraday manager service, as described herein, for example, in a database of the intraday manager service. An example JSON array of an SLA or plan may be: {“service_level_%_+_minutes”:[75.0,10.0], “workload_divisions”:[2,3,4,1,1]}, e.g., where workload in terms of divisions is split into an array for voice, chat, text, face to face, and other interactions. By way of another example an SLA or plan may be: {“AHT_seconds”:1023}.

As used herein, “artificial intelligence” or “AI” may refer to “intelligence” of machines or computers (e.g., as opposed to intelligence of humans). AI may be categorized in various ways and many different AI models exist. AI may, at least in a large number of cases, refer to computational models which gain intelligence through “learning”, such as machine learning or deep learning, rather than being explicitly coded to execute a specific algorithm. Such models may make predictions or decisions without being explicitly programmed to do so. Learning may include building models in response to/based on input sample or training data.

As used herein, “generative AI” may refer to deep learning AI models that may have been trained using large quantities of (often unlabeled) data. Generative AI models may generate predictions or decisions without being explicitly programmed to do so. Generative AI may, for example, include large language models, computer vision models, code completion models, or other examples as may be known in the art. Generative AI models typically include neural networks (NNs), computational constructs simulating the operation of many thousands of neurons, simple computational units, connected to each other by links. Generative AI models may be generalist, in that, in their construction, they may not be directed to a particular use. However, generalist models may, given the large quantities of data used during construction, still be effective for particular uses. In some embodiments, the utility of generative AI models may be enhanced by tuning the model with additional data, for example, as may be relevant to a particular use. In some embodiments, generative AI models may be provided with “prompts” which may provide additional data for the model and/or may deliver a request or question for the model to respond to. Generative AI models, as referred to herein, may be owned operated and/or run by a third party, such as popular generative AI models like ChatGPT, GPT5, OpenAI, Claude, Cohere, BERT, etc. Alternatively, some generative AI models may be trained for a specific use, and/or may be given data directly relevant to their intended use during training.

As used herein, “large language model” or “LLM” may refer to a type of generative AI model that is capable of understanding text or language-based prompts and generating text or language-based responses. For example, responses of LLMs may mimic the text or language-based response that a human could provide.

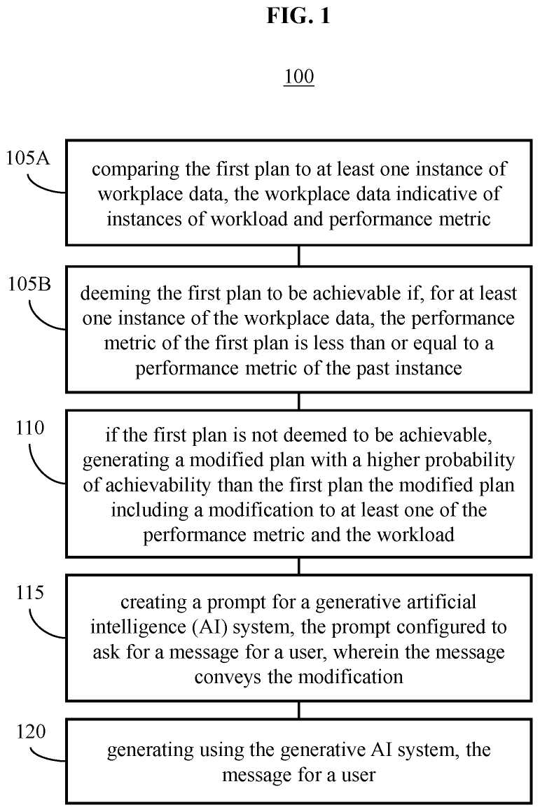

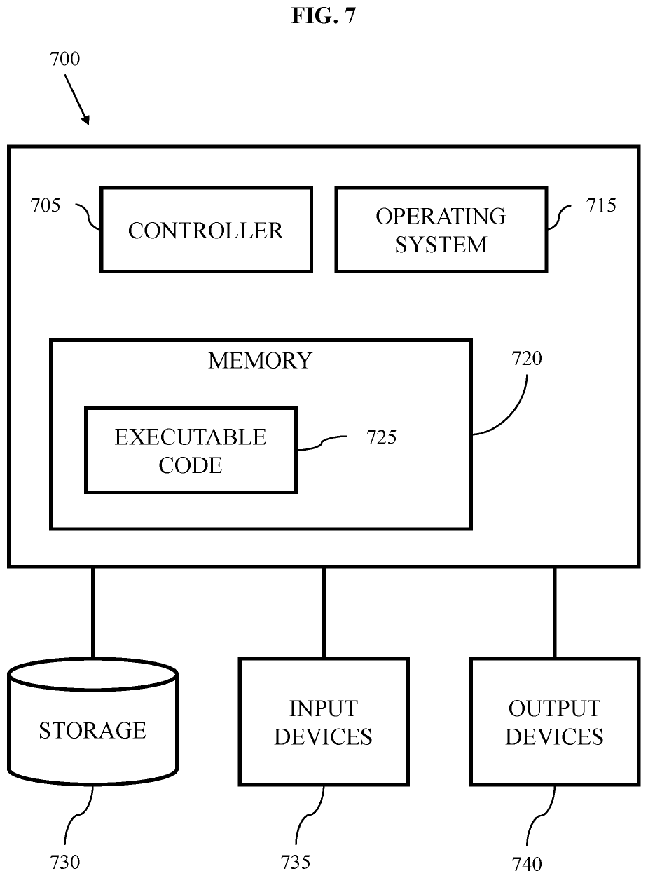

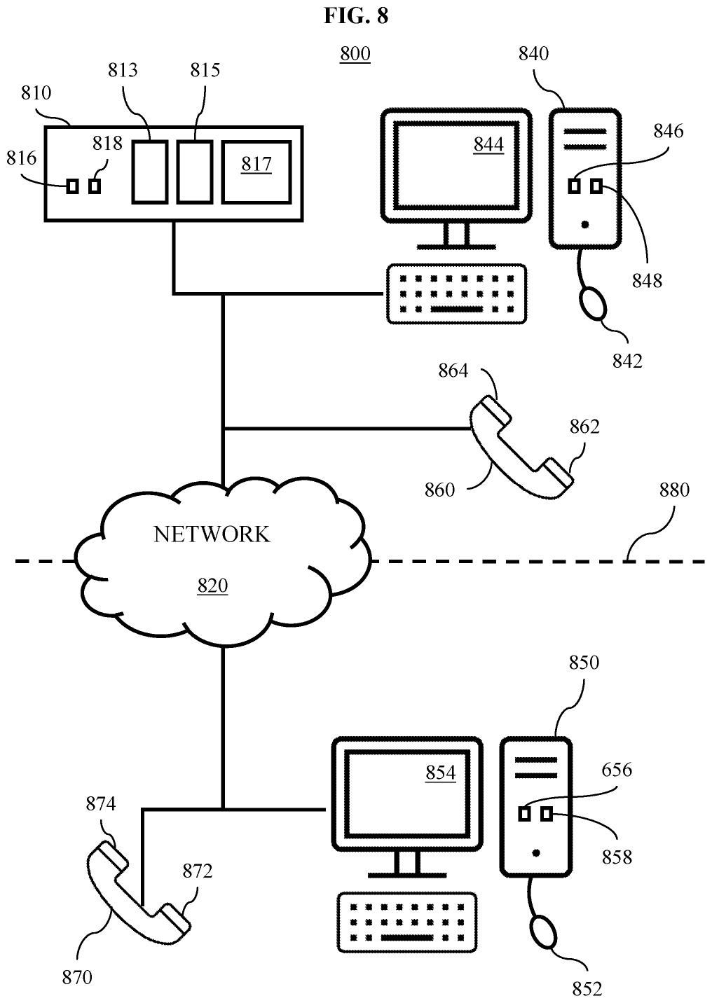

FIG. 1 shows a method 100 for generating changes to a plan according to some embodiments of the invention. The plan may include a workload and/or a performance metric. The plan may be a workplace plan for a contact center (or similar). Method(s) of FIG. 1 and the other flowcharts disclosed herein may be configured to be carried out by a computing device or processor, for example, as described in FIGS. 7 and 8. Some embodiments herein include a computing device or processor (e.g., as described in FIGS. 7 and 8) configured to carry out the method of FIG. 1 and/or the other flowcharts disclosed herein.

In some embodiments, method 100 may be carried out (e.g., simultaneously) for each of a number of interaction types. The interaction types may be types of interaction that may be carried out (e.g., simultaneously) by a contact center. The interaction types may include, for example, voice-based interactions, text-based interactions, video-based interactions, face-to-face interactions, and/or other interactions.

In operations 105A and 105B, it may be estimated whether a first plan is achievable, by comparing the first plan to past workplace/contact center data. The first plan may comprise a workload and a performance metric, e.g., proposed for a contact center. The first plan may be compared (e.g., in operation 105A) to at least one instance of workplace data. The workplace data may be indicative of instances of workload and performance metric. The instances may be previous or prior to the time of the first plan. The first plan may be deemed to be achievable (e.g., in operation 105B) if, for at least one instance of the workplace data, the performance metric of the first plan is less than or equal to a performance metric of the past instance. In some embodiments, the first plan may be deemed to be achievable if, for all instances of the workplace data, the performance metric of the first plan is less than or equal to a performance metric of the past instance. In other words, if the new proposed plan includes a performance metric greater than has ever been achieved before, it is unlikely to be achievable.

As used herein, “instances” may refer to times during which a workplace, e.g., a contact center, operated in the past, wherein data was collected about the operation of the workplace during that instance. Instances may relate to periods of time, e.g., a day, a week, a month, etc. Instances may relate to a same or similar period of time as time periods over which SLAs or plans are applicable. Data may include workload, performance metrics, plans, etc. For example, a contact center (possibly a same, similar, or different contact center to that for which method 100 is to be carried out) may have operated at a recorded workload, e.g., how many calls or contacts per hour. While the contact center was in operation, data may have been collected or recorded about its operation, for example, its workload, the types of interactions it was dealing with, performance metrics about the contact center operation. For example, data may be recorded that indicates that, on a particular day, two divisions in a call center dealt with 2300 voice calls, and achieved a service level of 72% of voice calls answered within 30 seconds, with an occupancy rate of 88%, and an average wait time of 28 seconds. It may be recorded that this met an agreed service level agreement or plan that stipulated a service level of at least 70% of voice calls should be answered within 30 seconds.

In the context of operations 105A and 105B, “less than or equal to” may refer to “worse than or the same as”. Usually, performance metrics indicate better quality at high numbers and worse quality at low numbers. Where a performance metric increases with increased quality, e.g., a service level is “better” at larger percentages, the above distinction may be unimportant. Where a performance metric decreases with increased quality, e.g., wait time is “better” at lower numbers, this distinction may be important. In the example of where a performance metric decreases with increased quality, operations 105A and 105B may be straightforwardly understood as deeming a first plan to be achievable if, for at least one instance of the workplace data, the value of the performance metric of the first plan is more than or equal to the value of the performance metric of the past instance (e.g., without operations 105A and 105B needing to be rewritten).

When comparing the first plan to at least one instance of workplace data, the workplace data and the first plan may both relate to a same interaction type. Where the first plan includes multiple interaction types, a comparison may take place separately for each interaction type of the first plan.

A plan that is deemed to be achievable may have a high achievability score, whereas a plan that is not deemed to be achievable may have a low achievability score. An achievability score may be based on the comparison of the first plan to the at least one instance of workplace data. An achievability score may additionally give an indication of the extent to which a plan is achievable or not (e.g., a difference of the numbers).

By way of an example of operations 105A and 105B, an example call center have a (proposed) performance metric of AHT of 20 minutes for voice calls. The following workplace data for previous instances of workplace data for voice calls (e.g., stored or transferred in an array) may exist: [25.3, 31.0, 22.1, 18.4, 19.6, 21.0]. The plan is to be achievable if, for at least one instance of the workplace data, the value of the performance metric of the plan is more than or equal to the value of the performance metric of the past instance. In this case, the example value of 20 may be compared to each of the following example values: 25.3, 31.0, 22.1, 18.4, 19.6, 21.0. In this case, 20>18.4 and 20>19.6. It will be recognized that, as soon as a lower value is found in the workplace data, the comparison does not need to continue (e.g., after finding 18.4 the comparison may stop. To improve comparison speeds, the workplace data may be sorted before comparing (e.g., in ascending order to give [18.4, 19.6, 21.0, 22.1, 25.3, 31.0]), and then only one comparison need be made, e.g., 20>18.4. In this example (given 20>18.4), the performance metric and/or the plan including the performance metric is deemed to be achievable.

By way of another example, a plan may have a service level of 90% of web chats answered within 10 minutes. The following example e workplace data for previous instances of workplace data for web chats and/or other types of text-based interactions (e.g., in this case, each instance may correspond to being answered within 10 minutes, and the percentage/first number is in an array) may exist: [88, 75.4, 70, 82, 62]. The plan is to be achievable if, for at least one instance of the workplace data, the value of the performance metric of the plan is less than or equal to the value of the performance metric of the past instance. In this case, the value of 90 may be compared to each of the following values: 88, 75.4, 70, 82, 62. It will be recognized that, as soon as a lower value is found in the workplace data, the comparison does not need to continue. To improve comparison speeds, the workplace data may be sorted before comparing (e.g., in descending order to give [88, 82, 75.4, 70, 62]), and then only one comparison need be made, e.g., 90>88. In this example (given 90>88), the performance metric and/or the plan including the performance metric is not deemed to be achievable.

In operation 110, if the first plan is not deemed to be achievable, a modified plan with a higher probability of achievability than a probability of achievability of the first plan may be generated. The modified plan may include a modification to the performance metric, and/or the workload. For example, the performance metric may be decreased. In some cases performance metric modifications may be made separately for each interaction type. In other embodiments, changes may be made to other values, for example, a workload (e.g., in order to meet the performance metric, fewer contacts need to be handled). A modified plan may not need to be detailed, for example, a modified plan may include an indication that one or more of the following needs to be reduced: a number of contacts of a certain skill type, a performance metric to be met, and/or any part of an SLA.

In some cases, for example, where the first plan relates to multiple interaction types, multiple modified plans may be produced. For example, where a first plan which relates to voice-based interactions and text-based interactions is not deemed to be achievable, two modified plans may be generated: one which includes a decrease in performance metric for the voice-based interactions, and the other which includes a decrease in performance metric for the text-based interactions. There could also be one or more additional plans involving a decrease in service for both voice-based and text-based interaction types.

In operation 115, a prompt for a generative artificial intelligence (AI) system may be created. The prompt may be configured to ask for a message for a user, wherein the message conveys the modification. The message may state that the first plan should be replaced with the modified plan and/or state the modification to the performance metric or workload of the modified plan.

If there are multiple modified plans, the prompt may be configured to ask for a message for a user, which tells the user that there is a choice between multiple modified plans and/or states the modifications of each plan.

The generative AI system may be a large language model (LLM). The prompt may be text-based.

For example, the prompt may have the following template: “frame a sentence that tells user that the user can choose one option among the following ‘as per historical data of last <param1> we recommend <param2> % SLA and to achieve this you have the option to decrease the number of simultaneous <param3>’”, wherein <param1> is a period over which workplace data was recorded/captured, <param2> gives a performance metric value (in this case service level), and <param3> lists interaction types which are relevant to the particular instance. For example, one instance of the prompt given to the generative AI system is the following: “frame a sentence that tells user that the user can choose one option among the following ‘as per historical data of last 1 month we recommend 75% SLA and to achieve this you have the option to decrease the number of simultaneous chat, voice”. Many alterations of this prompt may be possible, for example, the prompt may be modified to use different performance metrics.

In operation 120, the message for a user may be generated using the generative AI system. In some embodiments, this operation may not be executed by the same computing device or processor as used during other operations. In some embodiments, operation 120 may additionally or alternatively include receiving the message for a user from the generative AI system.

In the following message examples, the performance metric is a service level, wherein the selected service level is 75% contacts answered within 30 seconds and the workplace data is from the previous three weeks. These parameters are merely exemplary. Where there is a single modified plan (e.g., where there is one interaction type), the message may be similar to the following: “Based on historical data from the last 3 weeks for an SLA of 75%, you have to decrease the number of simultaneous Chat contacts.” Where there are multiple modified plans (e.g., where there are multiple interaction types), the message may be similar to the following: “Based on historical data from the last 3 weeks for an SLA of 75%—you have the option to choose one of the following: 1) decrease the number of simultaneous Chat contacts, 2) decrease the number of simultaneous Text contacts, or 3) decrease the number of simultaneous Other contacts.”

Where there are multiple modified plans, a user may confirm or select which modified plan or plans are to be carried out. Where there is one modified plan, this may not be necessary, however, a user may still confirm that the modified plan is to be carried out.

In some embodiments, a staffing schedule may be created for delivering the modified plan (e.g., the selected modified plan where multiple modified plans exist). Creating a staffing schedule may be carried out using a generative AI. For example, a generative AI may be sent data indicative of the modified plan and staffing, and a prompt asking for a staffing schedule. In some embodiments, the modified plan may be transferred to an automatic call distributor of a contact center (e.g., as referred to in FIG. 8). The automatic call distributor may route contacts of the contact center (e.g. distribute data streams representing interactions or calls via computer hardware as discussed herein, or other hardware) to agents of the contact center in accordance with the modified plan and/or in accordance with schedules (e.g., staffing schedules) based on the modified plans.

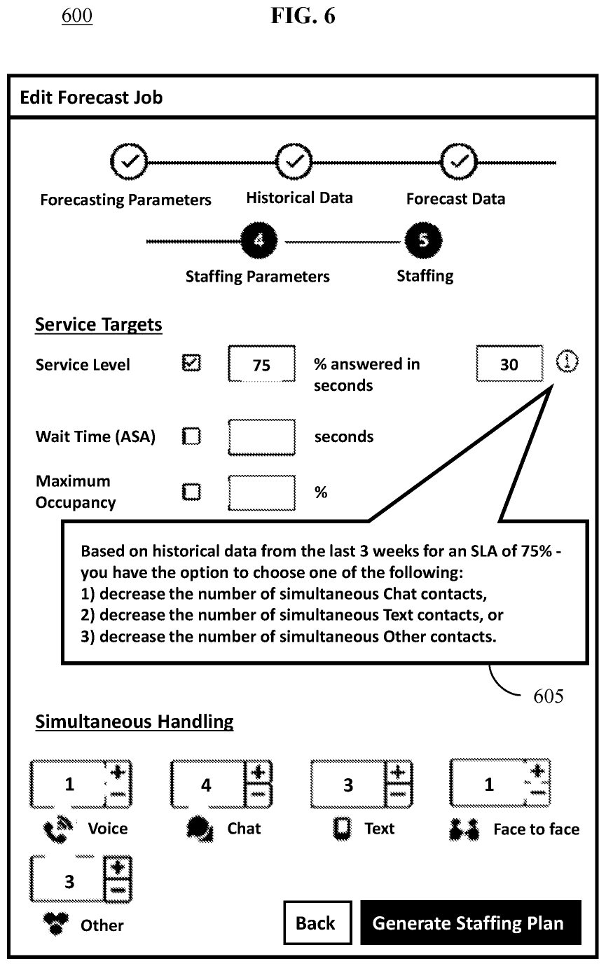

In some embodiments, the modified plan may be output for displaying to a user. For example, the modified plan may be displayed using a computing device and a graphical user interface, e.g., as shown in FIG. 6.

In some embodiments, the modified plan may be output to a workplace or contact center (e.g., a server of a workplace or contact center), such that operations (e.g., distribution of contacts) may take place in accordance with the modified plan. The workplace or contact center may be, for example, as shown in FIG. 8. For example, an automatic call distributor (ACD) of a contact center may use a plan in order to assess which computers or telephones to distribute one or more calls or contacts to (e.g., in accordance with a workload and/or performance metric of the plan).

In some embodiments, a method for assessing the feasibility of a proposed contact center work plan, including a proposed workload and a proposed performance metric, may include: generating, based on the proposed contact center work plan and data indicative of previous feasible contact center work plans, a feasibility score for the proposed contact center work plan; and where the feasibility score is below a threshold, generating, using a large language model, a modified contact center work plan for a user with a feasibility score above the threshold, the modified contact center work plan comprising a modification to one or more aspects of the contact center work plan.

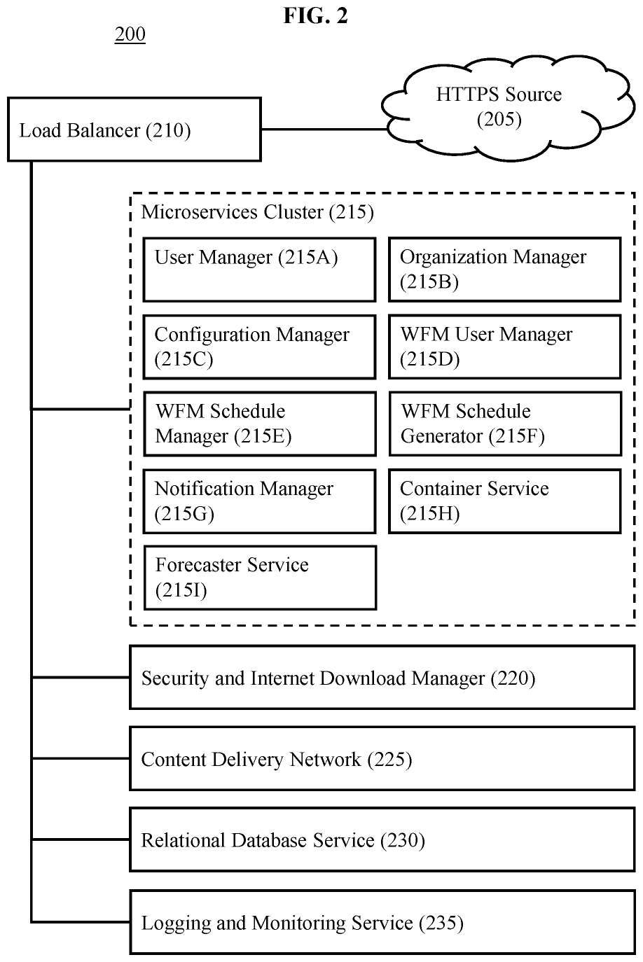

FIG. 2 shows a network architecture 200 diagram which may be used with embodiments herein.

Component 205 may be or may include a source of data. The data from the data source may be transferred using HTTP (Hypertext Transfer Protocol) or HTTPS (Hypertext Transfer Protocol Secure). The data source may be external in some sense to the other components of FIG. 2; for example, the data source may interact with the rest of the network architecture 200 via a network and/or the internet. The data source may include a contact center, a call center, a workplace, etc. The data source may include an data store, such as a database.

Component 210 may interface between an external network such as the internet and the network architecture 200. Component 210 may be or may include a load balancer, for improving performance, such as by reducing network latency. Component 210 may be or may include other tools or services, such as a proxy or an HTTP cache. Component 210 may, for example, include an Amazon Route 53 Resolver, an Amazon Elastic Load Balancer (ELB), an NGINX server, etc.

Component or cluster 215 may include components or modules for carrying out services (e.g., microservices) in the network, and may be called a microservices cluster. Microservices cluster 215 may include: a User Manager 215A; an Organization Manager 215B (which may manage the tenants in the organization; a Configuration Manager 215C (which may provide configuration to other services); Workforce Management (WFM) User Manager 215D (which may contain additional user data with relation to WFO such as Skills, Scheduling attributes, etc.); Workforce Management (WFM) Schedule Manager 215E, for storing and/or retrieving schedule data, net staffing data, and/or configurations for generating schedules, including daily rules, weekly rules, and activity codes; Workforce Management (WFM) Schedule Generator 215F (which may implement algorithm(s) for Generating Schedules and Shift Bid Weekly Patterns based on System constraints such as weekly and daily work rules, staffing requirements and preferences of employees); Notification Manager 215G (which may send notifications to clients via Push notification, SMS, email, etc.); Container Service 215H (which may be an AWS service which contains all the application services); and/or Forecaster Service 215I, for generating forecasts based on historic data, automatically generating staffing plans based on forecasts, providing data such as forecasts to a client, and/or managing forecasting profiles. WFM Schedule Manager 215E may store and retrieve schedule data, net staffing data, and configurations required to generate schedules including daily rules, weekly rules, and activity codes; this may store the shift trade configuration of the system. This list may not be exhaustive; the services of network architecture 200 may vary based on circumstances and needs.

Embodiments herein may relate, in particular, to the forecaster service 215I. Method embodiments, such as those of FIGS. 1, 4A, 4B, 5, and 6 may be executed, at least in part, using a forecaster service.

Component 220 may be or may include Security services and/or an Internet Download Manager. Component 220 may, for example, include Keycloak, which may provide single sign-on (SSO) access to applications and services, where users need only to authenticate once and can access multiple applications without needing to re-enter credentials.

Component 225 may be or may include a Content Delivery Network, e.g., for providing proxy servers for caching content. Component 225 may, for example, include an Angular Web Application, Amazon S3, and/or Amazon CloudFront.

Component 230 may be or may include a Relational Database Service, e.g., for assisting with relational database management tasks, such as data migration, backup, recovery, and patching. Component 230 may, for example, include Amazon Relational Database Service (RDS).

Component 235 may be or may include a Logging and Monitoring Service, e.g., for collecting and tracking metrics that measure resources and applications. Component 235 may, for example, include Amazon Cloudwatch.

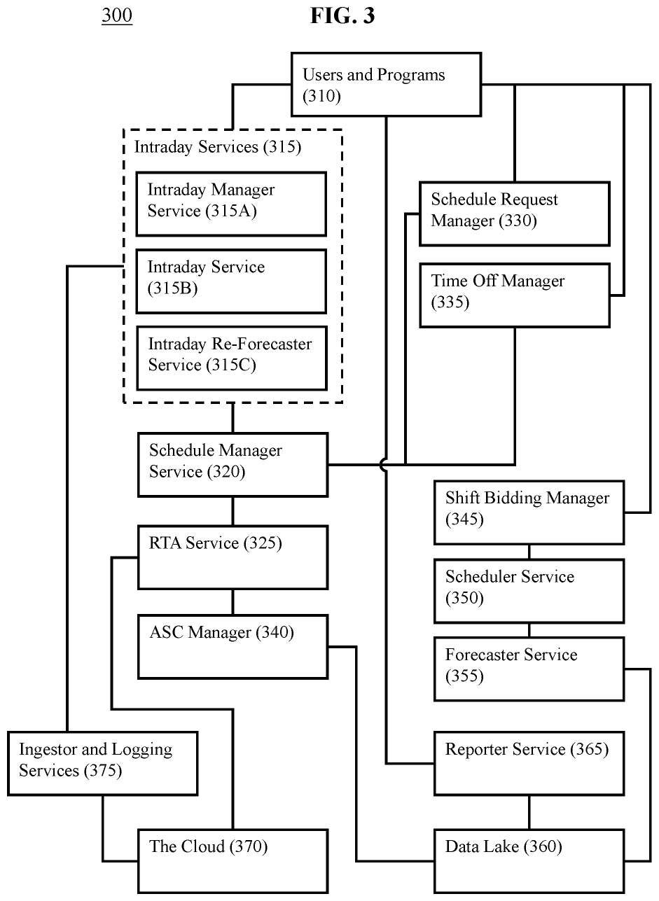

FIG. 3 shows a software architecture 300 diagram of at least part of a system which may be used with embodiments herein.

Component 310 may be or include software or programs associated with an input and/or output of data by a user or supervisor. The input and/or output of data may take place through a computer or input and output devices associated with a computer. The input and/or output of data may allow a user or supervisor to provide inputs to the system to control the actions of the system or to provide information to the system, and/or to view outputs of the system.

Component 315 may be or may include intraday services and/or an intraday service cluster. The intraday services may include an intraday manager service, an intraday service, and an intraday re-forecaster service. “Intraday” may refer to the fact that the services relate to a workday that is presently taking place.

Component 315A may be or may include an intraday manager service. The intraday manager service may display intraday (e.g., performance) metrics data (e.g., actual, forecasted, or the variance between actual and forecasted) for one or more skills for a time range, e.g., every 15 minutes over a 24-hour period, such as the last day. Forecasted data may be compared with actual data and variance may be derived to obtain an understanding of whether the contact center is understaffed or overstaffed.

Component 315B may be or may include an intraday service. The intraday service may be responsible for responsible managing and/or displaying data and/or metrics that are part of a user dashboard, e.g., data that is displayed to a supervisor.

Component 315C may be or may include an intraday re-forecaster service. Reforecasting may relate to the updating of an existing forecast for the rest of a day/workday, wherein the update may be based on a forecast and more recent data from an ACD (e.g., of a contact center). An intraday re-forecaster service may perform for example: retrieving forecast data from a schedule manager and/or saving it to a logging service (e.g., as part of component 375); and calculating reforecast data (e.g., an updated forecast for the rest of the day) for relevant tenants or contact centers (e.g., that have indicated desire for reforecasting) and/or saving results to a logging service (e.g., as part of component 375). The data may relate to at least one of: performance metrics (e.g., average handle time (AHT), average speed of answer (ASA), contact volume), service level agreements (SLA), and staffing levels. The intraday re-forecaster service may, for example, run every 15 minutes.

Component 320 may be or may include a schedule manager. The schedule manager may be a core application in a scheduling ecosystem (e.g., a collection of services related to scheduling). The schedule manager may be responsible for storing and retrieving schedule data, net staffing data, and configurations required to generate schedules, e.g., including daily rules (e.g., a configuration defining properties of a shift, such as length of shift, activities included in the shift, and duration of each activity), weekly rules (e.g., one or more daily rules), and activity codes (e.g., which may represent schedule activities including break, lunch, meeting, time-off, etc.). The schedule manager may store a shift configuration.

Component 325 may be or may include a real-time adherence (RTA) service. The RTA may be responsible for calculating an employee adherence status by comparing activity of the employee with an expected activity of the employee. The employee may be found to be in adherence or out of adherence (e.g., acting as expected or not acting as expected, respectively). An employee that is out of adherence may need to be investigated or spoken to, to understand anomalous (non-adherent) activity.

Component 330 may be or may include a schedule request manager (SRM). The SRM may manage schedule change requests (SCRs), which may be generated by one or more agents. The SRM may perform for example: adding, editing, fetching, approving, and/or declining SCRs; calling a schedule rules automation service in order to validate a new or edited SCR against any scheduling rules that may exist; saving the SCRs, e.g., with the schedule manager service 320; sending notifications to managers/supervisors or users for new SCRs; sending notifications to agents regarding whether an SCR has been approved or declined; and/or storing data in a relational database service (e.g., 230).

Component 335 may be or may include a time off manager service. The time off manager may be configured to carry out for example: define time off rules, calculate time off balances for agents, and generate an API for automatic or semi-automatic approval.

Component 340 may be or may include an Agent State Connector (ASC) manager. The ASC manager may integrate or coordinate between a WFM application (e.g., software architecture 300) and automatic call distributors or contact centers, e.g., as depicted in FIG. 8 (which may be external to software architecture 300 and may be accessible via the cloud 370). The ASC manager may: retrieve historical/agent-state data (e.g., on what has happened at a contact center), format the historical data, and/or provide reports based on the historical data.

Component 345 may be or may include a shift bidding manager service. A shift bidding manager service may be responsible for managing agent bids for specific shifts that are made available for bidding. The shift bidding manager service may be responsible of managing data flows and data related to shift bidding. Shift bidding may allow a supervisor to define different weekly work schedules and open them for bidding for a number of agents (e.g., agents of a specific unit). Each agent may enter into the generated bid and may prioritize the weekly schedules. Thereafter, assignment of schedules may take place based on the agents' rankings.

Component 350 may be or may include a scheduler service. The scheduler service may generate agent schedules. Schedules may be generated in accordance with a modified plan or SLA.

Component 355 may be or may include a forecaster service. In some embodiments, the forecaster service may be configured to carry out some or all of the method operations herein. The forecaster service may forecast values for performance metrics, such as a future call volume, a future service level, or an average handle time (AHT). The forecaster service may additionally or alternatively generate staffing plans, wherein the staffing plans generation may be automatic. The forecaster service may perform for example: consume historical data and then generate forecasting; take performance metrics or service targets as an input along with the forecasts to automatically generate a staffing plan or SLA; and provide historical data, forecasting, and staffing plan chart data to a user. While setting forecasting parameters such as Performance metric targets, historic data may be collected and compared. Additionally, Generative AI may be utilized (e.g., through an API) to produce a user message which may help the user understand the system better and set accurate performance metric targets.

Embodiments may relate, in particular, to the forecaster service 355. Method embodiments, such as those of FIGS. 1, 4A, 4B, 5, and 6 may be executed, at least in part, using a forecaster service.

Component 360 may be or may include a data lake. The data lake may be known as an enterprise data lake.

Component 365 may be or may include a reporter service.

Component 370 may be or may include an external connection, source, server, and/or connection over the internet. For brevity, it may be referred to as the cloud. The cloud may be used for connecting to automatic call distributors or contact centers (e.g., as described in FIG. 8). Data may arrive at the software architecture 300 from the cloud.

Component 375 may be or may include an ingestor service and/or a logging service. The ingestor service may be responsible for ingesting or importing data and metrics, e.g., from an external source such as the cloud 370. The data and metrics may be for use by the intraday services 315. The intraday service may use an API. The ingestor service may, for example, include an InContact API in operation with an Amazon Kinesis Stream and an Amazon S3 service. The logging service may, for example, include an Amazon Elasticsearch service.

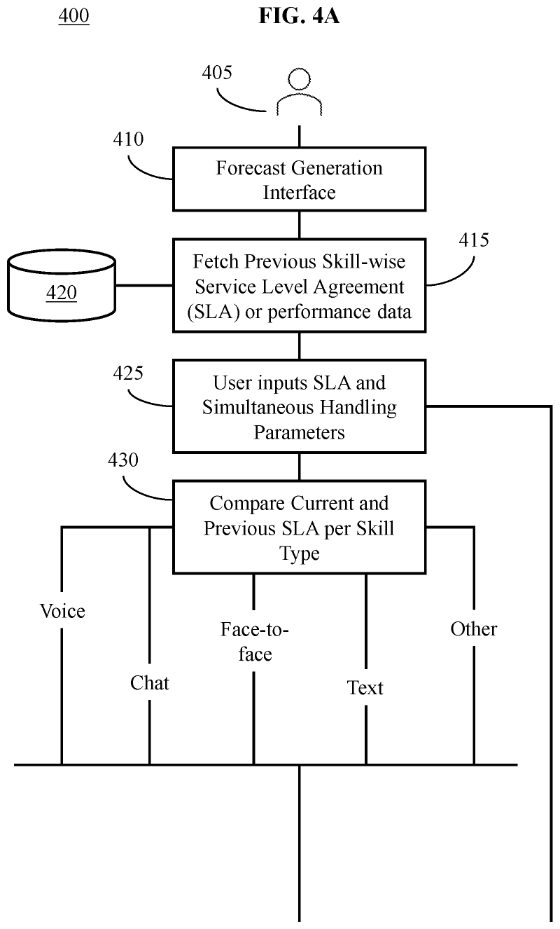

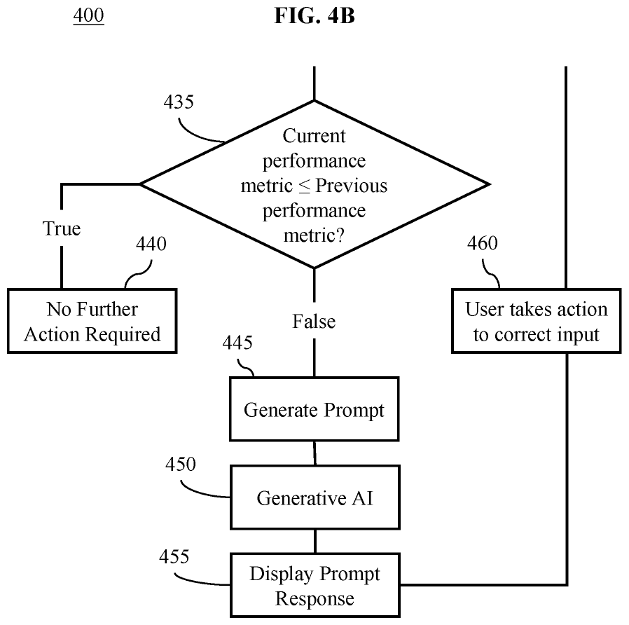

FIGS. 4A and 4B show a flowchart or a workflow according to some embodiments herein.

Firstly, a forecast generation may be initiated. A supervisor or user 405 may initiate forecast generation via a forecast generation interface 410 (e.g., of a workforce management application). A forecast may include predictions for various aspects of a workplace, a data center, a contact center, etc., such as workload, demand, or performance metrics.

In operation 415, a performance metric of at least one previous service level agreement (SLA), or similar, may be fetched from a computational memory 420. The at least one SLA (or similar) may be categorized in terms of a type of skill to which the SLA relates. For example, skills may include: voice calls, web or text chats, face-to-face interactions, text-based interactions, and others. Additionally or alternatively, the performance metric may be of at least one actual instances (performance data) of the running of contact center (e.g., where previous performance metrics were measured, not just agreed to in an SLA).

In operation 425, an SLA or first plan, which may include one or more performance metrics, and possibly simultaneous handling parameters (e.g., which and how many different skill types), may be input (e.g., by supervisor or user using component 405) for a potential or proposed new SLA or first plan.

In operation 430, the performance metric(s) of the potential or proposed new SLA (or a first plan comprising a current performance metric) may be compared to the performance metric of the at least one previous SLA or plan, or a previous instance of workplace/contact center data (each of which may include a previous performance metric, either measured or proposed). The comparison may account for skill types; the current performance metric and previous performance metric may be comparable if they relate (at least in part) to the same or similar skill type. Where the current performance metric and/or previous performance metric relate to more than one skill type, each skill type may be compared separately. Where the current performance metric relates to more than one skill type, skill type comparisons may take place in parallel for each skill type.

In operation 435, it may be asked or ascertained whether, for each skill type relevant to the current performance metric, the current performance metric is less than or equal to the previous performance metric. If the current performance metric is less than or equal to one or more previous performance metrics (e.g., the above statement is True), then it may be that no further action is required 440. If the above statement is False, the process may move to operation 445. If the above statement is True, the proposed new SLA or first plan may be deemed to be achievable.

Operations 430 and 435 may estimate whether a first plan or input proposed service level agreement (SLA) is achievable.

In the context of operation 435, “less than or equal to” may refer to “worse than or the same as”. Usually, performance metrics indicate better quality at high numbers and worse quality at low numbers. Where a performance metric increases with increased quality, e.g., a service level is “better” at larger percentages, the above distinction may be unimportant. Where a performance metric decreases with increased quality, e.g., wait time is “better” at lower numbers, this distinction may be important. In the example of where a performance metric decreases with increased quality, operation 435 may be straightforwardly understood as asking or ascertaining whether, for each skill type relevant to the current performance metric, the value of the current performance metric is more than or equal to the value of the previous performance metric (e.g., without operation 435 needing to be rewritten).

Operation 445 may take place if the first plan or new SLA is not deemed to be achievable (e.g., the outcome of operation 435 is False). Operation 445 may include generating a modified plan with a higher probability of achievability than a probability of achievability of the first plan, wherein the modified plan may comprise a modification to the performance metric. In operation 445, a prompt may be created or generated for a Generative AI 450. The prompt may ask the Generative AI for a message for a user, wherein the message states that the first plan or proposed new SLA should be replaced with the modified plan (or modified SLA) and states the modification to a performance metric (e.g., service level) of the modified plan. For example, the prompt may have the following template (this template may allow for a reduction of workload, whereas other templates may allow for a reduction of performance metrics/other performance metrics): “frame a sentence that tells user that the user can choose one option among the following ‘as per historical data of last <param1> we recommend <param2> % SLA and to achieve this you have the option to decrease the number of simultaneous <param3>’”, wherein <param1> is a period over which workplace data was recorded/captured, <param2> gives a performance metric value (in this case service level), and <param3> lists interaction types which are relevant to the particular instance. For example, one instance of the prompt given to the generative AI system is the following: “frame a sentence that tells user that the user can choose one option among the following ‘as per historical data of last 1 month we recommend 75% SLA and to achieve this you have the option to decrease the number of simultaneous chat, voice”. Many alterations of this prompt may be possible, for example, the prompt may be modified to use different performance metrics.

In operation 455, a prompt response may be received from the generative AI and/or a prompt response may be displayed, e.g., on a monitor using a graphical user interface (GUI). In other words, the message for a user may be received, and/or the message for a user may be displayed to the user.

In operation 460, the user may take action to correct an input (e.g., the input provided in operation 425). The process may then return to operation 425. In other words, the method may be recursive or iterative in that it may check whether an amended plan made by the supervisor is achievable.

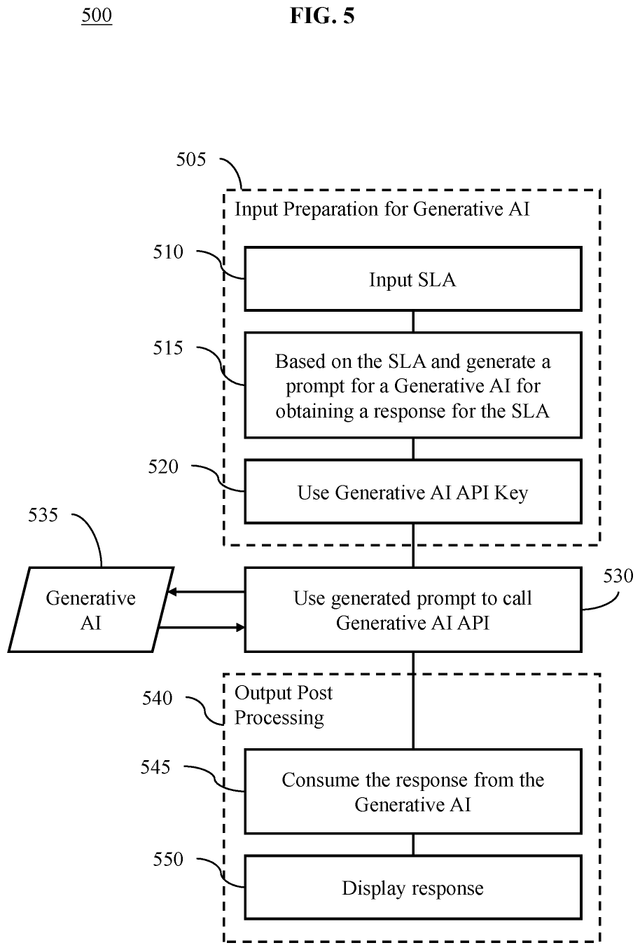

FIG. 5 shows a flowchart 500 according to some embodiments of the invention.

Operations within cluster 505 may relate to input preparation for the generative AI.

In operation 510, an indication of a proposed performance metric and/or service level agreement (SLA) may be input into a computational system (e.g., as a number percentage into a GUI). The performance metric may be or may form part of a first plan as discussed herein. The SLA may be a first plan as discussed herein.

In operation 515, a prompt for a generative AI may be generated, based on the input SLA (or performance metric), for obtaining a generative AI response for the SLA. Operation 515 may take place if the first plan/SLA/performance metric(s) is/are not deemed to be achievable. For example, operation 515 may take place if operation 435 of FIG. 4B outputs False. Operation 515 may correspond to operation 115 of FIG. 1.

In operation 520, an API key (in the case that one is required by the relevant generative AI) may be obtained and/or used, wherein the API key corresponds to an API (application programming interface), and this API may be used to interact with a generative AI 535.

In operation 530, the generated prompt may be sent to the generative AI 535 and/or a generative AI response may be received from the generative AI.

Operations within cluster 540 may relate to post-processing output of the generative AI response. For example, cluster 540 may relate to steps after 115 of FIG. 1 or 450 of FIG. 4B. In operation 545, the generative AI response may be consumed or received. This may, for example, include any of decoding, storing, or transferring of data containing the response.

In operation 550, the generative AI response may be displayed, e.g., using an output device of computing device. The response may be displayed to a user, e.g., as shown in FIG. 6. Operation 550 may additionally or alternatively include any automatic actions, such as creating a new staffing schedule.

FIG. 6 gives an example of a screenshot 600 of a display of a graphical user interface (GUI), according to some embodiments herein. The screenshot includes a service targets or performance metrics section, wherein there is an option to input service level, wait time, and maximum occupancy (e.g., different performance metrics for a contact center), in which a user has indicated a desire to use service level and achieve 75% of contacts answered in 30 seconds (e.g., from the beginning of each contact). The screenshot includes a simultaneous handling or skill type section, wherein a user has input a number of values corresponding to specific needs for different skill types (e.g., voice, chat, text, face to face, and other). The values input for different skill types may relate to numbers of business units. Alternatively, the numbers may relate to numbers of agents assigned for each skill. The screenshot also includes a displayed generative AI response (or message for a user) 605, which may be based on the desired service level (or similar) and the desired skill types to be served.

Any input performance metrics and/or simultaneous handling requirements may be evaluated to estimate whether a first plan is achievable, wherein the first plan may include performance metrics and/or simultaneous handling requirements that may have been input by a user in the GUI. The first plan may be compared to at least one instance of workplace data, the workplace data indicative of instances of workload and performance metric, the instances being previous to the time of the first plan, and deeming the first plan to be achievable where for at least one instance of the workplace data, the performance metric of the first plan is less than or equal to a performance metric of the past instance. If the first plan is not deemed to be achievable, a modified plan or plans may be generated with a higher probability of achievability than a probability of achievability of the first plan, wherein the modified plan may include a modification to the performance metric. In the example of screenshot 600, modified plans may include decreased the number of chat contacts, reduced the number of text contacts, and reduced numbers of other contacts. In other examples, modified plans may include a reduction to the performance metrics of the SLA, e.g., reducing the SLA to 70% answered in 30 seconds.

A prompt may be created for a generative artificial intelligence (AI) system, such that the prompt may be to ask for a message for a user, wherein the message states that the first plan should be replaced with the modified plan and states the modification to the performance metric of the modified plan. A prompt may be created and sent to a generative AI, for example, after each newly added input value, or change or edit to an input value (e.g., those shown in the screenshot). The message for the user may be received from the generative AI system. The displayed generative AI response/message for user 605 in this case is based on the input of service level of 75% answered in 30 seconds and multiple input skill types. The response reads: “Based on historical data from the last 3 weeks for an SLA of 75%-you have the option to choose one of the following: 1) decrease the number of simultaneous Chat contacts, 2) decrease the number of simultaneous Text contacts, or 3) decrease the number of simultaneous Other contacts.”

FIG. 7 shows a block diagram of an exemplary computing device which may be used with embodiments herein. Computing device 700 may include a controller or computer processor 705 that may be, for example, a central processing unit processor (CPU), a chip or any suitable computing device, an operating system 715, a memory 720, a storage 730, input devices 735 and output devices 740 such as a computer display or monitor displaying for example a computer desktop system.

Operating system 715 may be or may include code to perform tasks involving coordination, scheduling, arbitration, or managing operation of computing device 700, for example, scheduling execution of programs. Memory 720 may be or may include, for example, a Random Access Memory (RAM), a read only memory (ROM), a Flash memory, a volatile or non-volatile memory, or other suitable memory units or storage units. At least a portion of Memory 720 may include data storage housed online on the cloud. Memory 720 may be or may include a plurality of different memory units. Memory 720 may store, for example, instructions (e.g., code 725) to carry out methods as disclosed herein, for example, embodiments of methods and systems of FIGS. 1-6. Memory 720 may use a datastore, such as a database.

Executable code 725 may be any application, program, process, task, or script. Executable code 725 may be executed by controller 705, possibly under control of operating system 715. For example, executable code 725 may be, or may execute, one or more applications performing methods as disclosed herein, such as generating changes to a plan for a contact center. In some embodiments, more than one computing device 700 or components of device 700 may be used. One or more processor(s) 705 may be configured to carry out embodiments herein by, for example, executing software or code.

Storage 730 may be or may include, for example, a hard disk drive, a solid-state drive, a compact disk (CD) drive, a universal serial bus (USB) device or other suitable removable and/or fixed storage unit. Data described herein may be stored in a storage 730 and may be loaded from storage 730 into a memory 720 where it may be processed by controller 705. Storage 730 may include cloud storage.

Input devices 735 may be or may include a mouse, a keyboard, a touch screen or pad or any suitable input device or combination of devices. Output devices 740 may include one or more displays, speakers, virtual reality headsets, and/or any other suitable output devices or combination of output devices. Any applicable input/output (I/O) devices may be connected to computing device 700, for example, a wired or wireless network interface card (NIC), a modem, printer, a universal serial bus (USB) device or external hard drive may be included in input devices 735 and/or output devices 740.

Embodiments of the invention may include one or more article(s) (e.g., memory 720 or storage 730) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

Computing device 700 may additionally comprise a communication unit for communicating, transferring, transmitting, and/or receiving data to, from, or between another computing device (e.g., one similar to device 700).

FIG. 8 is a schematic drawing of a contact center system 800, which may be used with the present invention. Plans herein may be implemented on one or more contact center systems, such as that shown in FIG. 8.

System 800 may include a contact center and an agent. System 800 may be where a recorded interaction was carried out, recorded, and possibly stored. In some embodiments, the methods herein may be carried out in a system as described by system 800 (e.g., in server 810 or agent computer 844), whereas in other embodiments, the referred to call or interaction may take place in a system as described by system 800, and the methods of present invention may use the recording thereof, but may take place elsewhere (e.g., in another computing device, such as 700 of FIG. 7).

System 800 may include one or more server(s) 810, database(s) 815, telephones 860, 870, . . . , etc., and/or computer(s) 840, 850, . . . , etc., each of which may be or include computers (e.g., computer 500) or components, such as shown in FIG. 7. Any or all of system 800 devices may be connected via one or more network(s) 820. Network 820, which connects server(s) 810, computers 840 and 850, and/or telephones 860 and 870 may be any public or private network such as the Internet. Access to network 820 may be through wire line, terrestrial wireless, satellite, or other systems well known in the art.

Server(s) 810 and computers 840 and 700, may include one or more controller(s) or processor(s) 816, 846, and 856, respectively, for executing operations according to embodiments of the invention and one or more memory unit(s) 818, 848, and 858, respectively, for storing data (e.g., interactions) and/or instructions executable by the processor(s). Processor(s) 816, 846, and/or 856 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 818, 848, and/or 858 may include, for example, a random-access memory (RAM), a dynamic RAM (DRAM), a flash memory, a volatile memory, a non-volatile memory, a cache memory, a buffer, a short-term memory unit, a long-term memory unit, or other suitable memory units or storage units.

Computers 840 and 850 may be servers, personal computers, desktop computers, mobile computers, laptop computers, and notebook computers or any other suitable device such as a cellular telephone, personal digital assistant (PDA), video game console, etc., and may include wired or wireless connections or modems. Computers 840 and 850 may include one or more input devices 842 and 852, respectively, for receiving input from a user (e.g., via a pointing device, click-wheel or mouse, keys, touch screen, recorder/microphone, or other input components). Computers 840 and 850 may include one or more output devices 844 and 854 (e.g., a monitor, screen, or speaker) for displaying or conveying data to a user provided by or for server(s) 810.

Telephones 860 and 870 may be traditional telephones (e.g., landline telephones), and/or may be part of or in operation with one or more computers (e.g., smart phones and contact center phone systems), e.g., using voice over IP (VOIP) telephony. Telephones 860 and 870 may include one or more input components 862 and 872, respectively, for receiving input from a user (e.g., via a recorder/microphone, touch screen, or other input components). Telephones 860 and 870 may include one or more output devices 864 and 874 (e.g., a speaker, monitor, or screen) for conveying or displaying data (e.g., audio data from another telephone) to a user provided by or for server(s) 810.

In some embodiments, a first computer or telephone (e.g., contact center/agent computer or telephone) (e.g., 840 or 860) may be associated with a contact center and may be used by an agent, and a second computer or telephone (e.g., client computer or telephone) (e.g., 850 or 870) may be associated with or used by a client or customer. Each computer or telephone may record an input (e.g., sound of a conversation) and may transfer data indicative of this input to the network 820. Each computer or telephone may receive data indicative of an input from the network, possibly via a server 810, and may then output this data (e.g., data indictive of sound may be output using a speaker). The server 810 may be operated by the contact center. In some embodiments, all or part of the network 820 may additionally be associated with or operated by the contact center. Network 820 may be connected to more entities than those shown in FIG. 8. Network 820 may be connected to a computing device for generating changes to a first plan or a proposed SLA, according to embodiments herein.

In one example of a contact center interaction, an agent may ask a question into the microphone of an agent telephone, data representing this recorded sound may be transferred via a network and a server to a customer telephone, and the sound may then be output via the speaker of a customer telephone.

Server 810 may be responsible for managing interactions between agents and customers. Server 810 may be responsible for storing data as described herein, such as plans, previous data, and/or service level agreements.

Server 810, or another computational device configured to carry out embodiments of the invention. In some embodiments the server 810 may be configured to interact with a generative AI, which may reside remotely from server 810, e.g. in the cloud and/or accessible via a network such as network 820. In some embodiments, a generative AI may be executed by or at server 810. A generative AI may be a commercially available or off-the-shelf service or module, but may be other AI systems, such as a non-commercially available system trained for tasks specific to embodiments herein. In some embodiments, a generative AI may be accessed via an application programming interface (API).

Server 810 may include an automated or automatic call distributor (ACD). An ACD may be suitable for routing data representing incoming contacts and calls (e.g. data streams of interactions), e.g., from a client computer or telephone (850, 870), to a system or component that may allow an agent to respond to the incoming contacts and calls, e.g., to a contact center/agent computer or telephone (840, 860). The ACD may operate in accordance with a staffing schedule based on the plan or SLA according to embodiments herein. For example, an ACD may operate or change operation, according to the staffing schedule, to deliver a performance metric which may form part of a first plan or a modified plan according to the present invention. The plan may be calculated/generated using server 810 and/or the plan may be calculated/generated by a different computing device, and may be received at the server 810 using the network 820.

A plan (first or modified) or SLA according to embodiments herein may be carried out and/or adhered to by a workplace/contact center and/or a server such as server 810 and/or the ACD therein. An ACD may assign interactions/contacts agent computers or telephones (840, 860) in accordance with a plan or SLA.

Agent computers or telephones (840, 860) may be configured to operate for different interaction/contact types. For example, computers may be applicable for many different types of contact, whereas a telephone may be configured to operate primarily for voice call contacts.

In some embodiments, components above dashed line 880 may be associated with a contact center, whereas components below the dashed line 880 may be associated with clients and customers.

Any computing devices of FIGS. 7 and 8 (e.g., 700, 810, 840, and 850), or their constituent parts, may be configured to carry out any methods herein.

The embodiments herein may be incorporated into or form part of a larger platform or a system/ecosystem, such as workforce management (WFM) platforms. The platform, system, or ecosystem may be run using the computing devices of FIGS. 7 and 8, or their constituent parts.

Systems and methods herein may improve existing contact center plan formulation technology. For example, the present invention formulates plans quickly and possibly automatically, wherein the plans are achievable. The present invention may reduce user error. The present invention may allow for messages to be displayed to users/supervisors (e.g., as generated by generative AI) that are adaptable to different situations, are expressed in fluent language, and wherein responses do not need to be preprogrammed.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for generating changes to a first plan, the first plan comprising a workload and a performance metric, the method comprising:
estimating whether the first plan is achievable, comprising:
comparing the first plan to at least one instance of workplace data, the workplace data indicative of instances of workload and performance metric, the instances being previous to the time of the first plan, and
wherein the first plan is deemed to be achievable if, for at least one instance of the workplace data, the performance metric of the first plan is less than or equal to a performance metric of the past instance;
if the first plan is not deemed to be achievable, generating a modified plan with a higher probability of achievability than a probability of achievability of the first plan, the modified plan comprising a modification to at least one of the performance metric and the workload;
creating a prompt for a generative artificial intelligence (AI) system, the prompt configured to ask for a message for a user, wherein the message states that the first plan should be replaced with the modified plan and states the modification to the at least one of the performance metric and the workload of the modified plan; and
receiving from the generative AI system, the message for a user.

2. The method of claim 1, further comprising:
creating, based on the modified plan, a staffing schedule for delivering the modified plan.

3. The method of claim 2, wherein creating a staffing schedule is carried out using a generative AI.

4. The method of claim 1, wherein the method is carried out for each of a number of interaction types, the interaction types comprising at least one of:
voice-based interactions,
text-based interactions,
video-based interactions, and
face-to-face interactions.

5. The method of claim 4, wherein, when comparing the first plan to at least one instance of workplace data, the workplace data and the first plan both relate to a same interaction type.

6. The method of claim 1, wherein the modified plan comprises a decrease to the performance metric.

7. The method of claim 1, wherein the generative AI system is a large language model (LLM).

8. The method of claim 1, further comprising:
outputting the modified plan for displaying to a user.

9. The method of claim 1, wherein the first plan and the workplace data relate to a contact center or call center.

10. A system for generating changes to a first plan, the first plan comprising a workload and a performance metric, the system comprising:
a memory;
a processor, the processor configured to:
estimate whether the first plan is achievable, comprising the processor being configured to:
compare the first plan to at least one instance of workplace data, the workplace data indicative of instances of workload and, performance metric, the instances being previous to the time of the first plan, and
wherein the first plan is deemed to be achievable if, for at least one instance of the workplace data, the performance metric of the first plan is less than or equal to a performance metric of the past instance;
if the first plan is not deemed to be achievable, generate a modified plan with a higher probability of achievability than a probability of achievability of the first plan, the modified plan comprising a modification to at least one of the performance metric and the workload;
create a prompt for a generative artificial intelligence (AI) system, the prompt configured to ask for a message for a user, wherein the message states that the first plan should be replaced with the modified plan and states the modification to the at least one of the performance metric and the workload of the modified plan; and
receive from the generative AI system, the message for a user.

11. The system of claim 10, wherein the processor is further configured to:
create, based on the modified plan, a staffing schedule for delivering the modified plan.

12. The system of claim 11, wherein creating a staffing schedule is carried out using a generative AI.

13. The system of claim 10, wherein the processor is configured to carry out each method step for each of a number of interaction types, the interaction types comprising at least one of:
voice-based interactions,
text-based interactions,
video-based interactions, and
face-to-face interactions.

14. The system of claim 13, wherein, when the processor is configured to compare the first plan to at least one instance of workplace data, the workplace data and the first plan both relate to a same interaction type.

15. The system of claim 10, wherein the modified work plan comprises a decrease to the performance metric.

16. The system of claim 10, wherein the generative AI system is a large language model (LLM).

17. The system of claim 10, wherein the processor is further configured to:
output the modified plan for displaying to a user.

18. The system of claim 10, wherein the first plan and the workplace data relate to a contact center or call center.

19. The system of claim 10, wherein the modified plan is to be transferred to an automatic call distributor of a contact center, and wherein the automatic call distributor is to route contacts of the contact center to agents of the contact center in accordance with the modified plan.

20. A method for assessing the feasibility of a proposed contact center work plan comprising a proposed workload and a proposed performance metric, the method comprising:
generating, based on the proposed contact center work plan and data indicative of previous feasible contact center work plans, a feasibility score for the proposed contact center work plan; and
where the feasibility score is below a threshold, generating, using a large language model, a modified contact center work plan for a user with a feasibility score above the threshold, the modified contact center work plan comprising a modification to one or more aspects of the contact center work plan.
